(19) United States
(12) Patent Application Publication
(10) Pub. No.: US 2013/0038548 A1
(43) Pub. Date: Feb. 14, 2013

(54) TOUCH SYSTEM

(71) Applicants: Takashi KITADA, Fukuoka (JP); Tadashi MAKI, Fukuoka (JP)

(72) Inventors: Takashi KITADA, Fukuoka (JP); Tadashi MAKI, Fukuoka (JP)

(73) Assignee: PANASONIC CORPORATION, Osaka (JP)

(21) Appl. No.: 13/566,151

(22) Filed: Aug. 3, 2012

(30) Foreign Application Priority Data
Aug. 12, 2011 (JP) 2011-176536

(51) Int. Cl. G06F 3/041

(52) U.S. Cl. 345/173

(57) ABSTRACT

In a touch table system having a touch table apparatus provided with a touch panel main body in a tabletop and a PC connected to the touch table apparatus, the touch table apparatus has a touch position detector detecting a touch position within a touch detection area. A touch position converter converts a coordinate of a touch position into a coordinate of a screen area of the PC, the touch position being obtained in an operation is set for each user within the touch detection area.

### CROSS-REFERENCE TO RELATED APPLICATIONS

The present application claims priority under 35 U.S.C. §119 of Japanese Application No. 2011-176536 filed on Aug. 12, 2011, the disclosure of which is expressly incorporated by reference herein in its entirety.

### BACKGROUND OF THE INVENTION

1. Field of the Invention

The present invention relates to a touch system having a touch support member apparatus provided with a touch screen.

2. Description of Related Art

In a meeting where a screen of a PC is displayed on a large screen, an attendee uses a position input device, such as a mouse or a tablet, to operate the screen of the PC. In a case where one position input device is shared by a plurality of attendees, the attendees cannot readily operate the screen of the PC. Preparing a position input device for exclusive use for each of a plurality of attendees allows them to readily operate the screen of the PC. It is cumbersome, however, to prepare a large number of position input devices.

Thus, there is demand for a system that allows all attendees to readily operate a PC without providing exclusive position input devices to all the attendees. In connection with such a demand, a known technology is directed to a touch table apparatus having a touch screen in a tabletop (refer to Related Art 1). With such a touch table apparatus, users around the touch table apparatus can readily operate a screen of a PC.

To use a conventional touch table apparatus in a meeting, the touch table apparatus should have a size similar to a regular meeting table. With such a size of the touch table apparatus, however, it is sometimes difficult to reach a desired position on a touch surface of a tabletop while seated. In this case, a user needs to stand up and move from the user's seat to operate the screen, causing inconvenience.

[Related Art 1] Japanese Patent Laid-open Publication No. 2007-108678

### SUMMARY OF THE INVENTION

In view of the above circumstances, an advantage of the present invention is to provide a touch system configured to enhance convenience of use by a plurality of users.

A touch system comprising: a touch support member apparatus having a touch surface on which a touch operation is performed by a user and on which electrodes are arranged in a grid shape; and an information processing apparatus connected to the touch support member apparatus. The touch support member apparatus comprises: a touch position detector configured to detect a touch position on an operation area of the touch surface based on a change of output signals from the electrodes associated with a change in capacitance in response to the touch operation; and a touch position converter configured to convert a coordinate of the touch position, in the operation area, obtained by the touch position detector, into a coordinate of a screen area of the information processing apparatus

According to the present invention, the user has an operation area on the touch surface, thus enhancing convenience.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an overall configuration of a touch table system according to an embodiment of the present invention;

FIG. 2 is a perspective view illustrating an example of use of the touch table system;

FIG. 3 is a cross-sectional view of a panel main body incorporated in a tabletop of a touch table apparatus;

FIGS. 4A and 4B each illustrate a state in which an operation area is set for each user to operate a screen;

FIGS. 5A and 5B each illustrate a state in which an operation area is set for each user to operate a screen in another example;

FIG. 6 illustrates two-finger operation in which two fingers are used for position input operation;

FIG. 7 illustrates a state in which an operation area is designated on the touch table apparatus;

FIG. 8 is a perspective view of an area designation tool;

FIGS. 9A and 9B each illustrate a state in which an area is designated using the area designation tool;

FIG. 10 is a functional block diagram of the touch table apparatus and a PC;

FIG. 11 is a flowchart illustrating processing procedures in the touch table apparatus and the PC;

FIG. 12 is a flowchart illustrating processing procedures for operation area designation shown in a portion A of FIG. 11;

FIGS. 13A to 13D each illustrate a screen displayed on a display during operation area designation;

FIG. 14 is a flowchart illustrating processing procedures for screen operation shown in a portion B of FIG. 11;

FIGS. 15A and 15B each illustrate a state of coordinate conversion during screen operation;

FIG. 16 is a perspective view illustrating another example of use of the touch table system; and

FIG. 17 is a perspective view illustrating yet another example of use of the touch table system.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Embodiments of the present invention are described below with reference to the drawings.

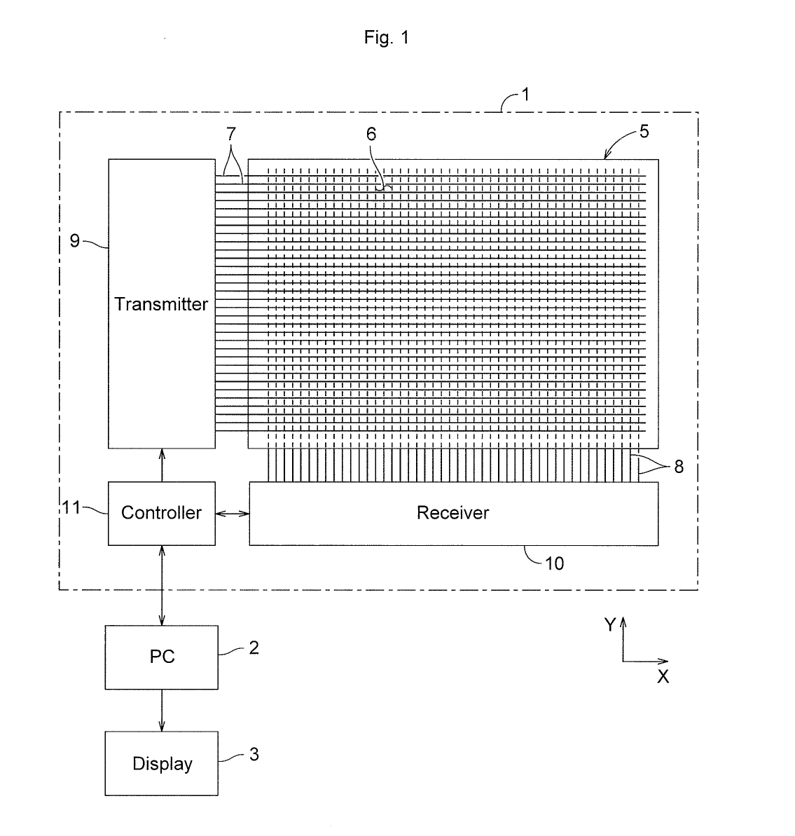

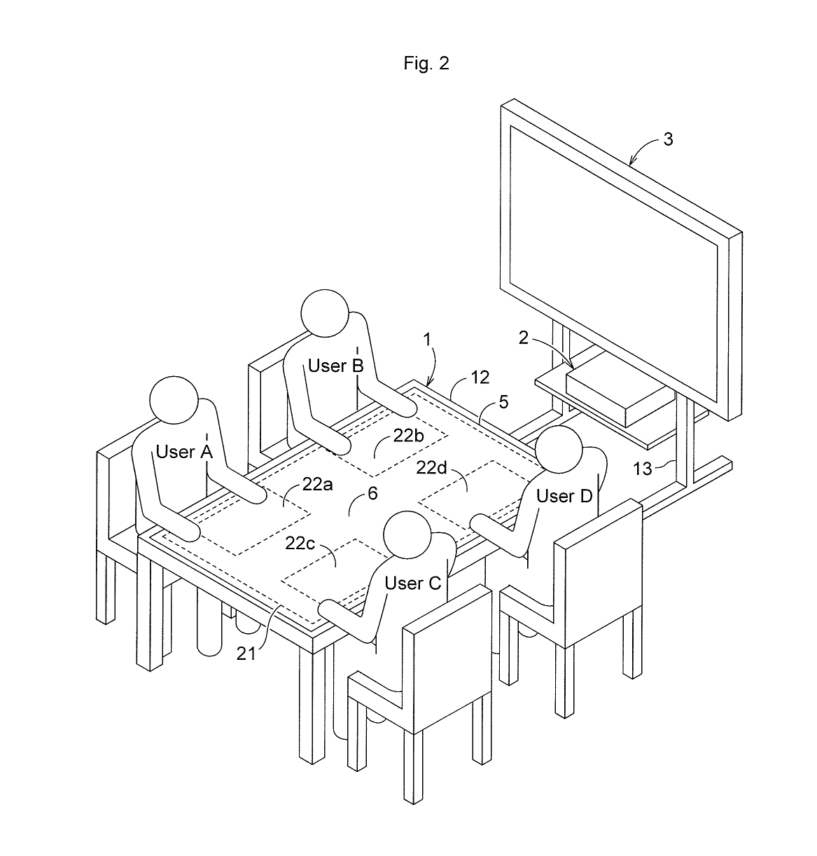

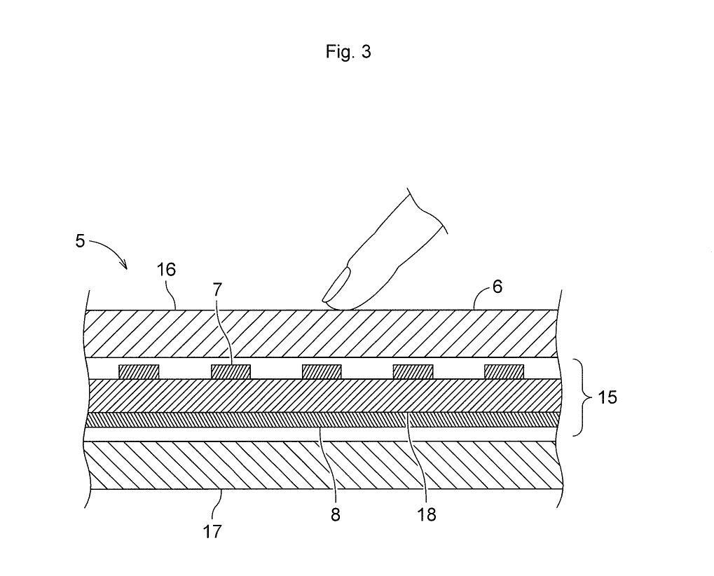

FIG. 1 illustrates an overall configuration of a touch table system according to an embodiment. FIG. 2 is a perspective view illustrating an example of use of the touch table system. FIG. 3 is a cross-sectional view of a panel main body 5 incorporated in a tabletop of a touch table apparatus 1.

With reference to FIG. 1, the touch table system includes the touch table apparatus 1, a PC (information processing apparatus) 2, and a display (display apparatus) 3.

The touch panel main body 5 of the touch table apparatus 1 has a touch surface 6 on which a touch operation is performed by a pointing object (conductive body, such as a user's finger or a stylus). The touch panel main body 5 includes a plurality of transmitting electrodes 7 in parallel to one another and a plurality of receiving electrodes 8 in parallel to one another, which are disposed in a grid pattern. With reference to FIG. 2, the touch panel main body 5 is disposed in a tabletop 12 of the touch table apparatus 1. An upper surface of the tabletop 12 serves as the touch surface 6 on which users A to D perform touch operations.

In the example of FIG. 2, the display 3 and the PC 2 are mounted on a stand 13 disposed beside the touch table apparatus 1. The users A to D seated around the touch table apparatus 1 each perform a touch operation on the touch table apparatus 1 while watching a screen of the display 3, and thereby operate a screen of the PC 2. A small footprint PC integrated with a display may be mounted on the tabletop 12 of the touch table apparatus 1.

With reference to FIG. 3, the touch panel main body 5 has an electrode sheet 15 including the transmitting electrodes 7 and the receiving electrodes 8, a front protection member 16 disposed on a front surface of the electrode sheet 15, and a rear projection member 17 disposed on a rear surface of the electrode sheet 15. In the electrode sheet 15, the transmitting electrodes 7 and the receiving electrodes 8 are disposed on front and rear surfaces, respectively, of a support sheet 18 that provides insulation between the transmitting electrodes 7 and the receiving electrodes 8. The front protection member 16 has the touch surface 6 on which a touch operation is performed by a pointing object, such as a finger. In order to increase detection sensitivity to touch operation by a pointing object, the front protection member 16 is composed of a synthetic resin material having high permittivity, such as, for example, a melamine resin.

As shown in FIG. 1, the touch table apparatus 1 has a transmitter 9, a receiver 10, and a controller 11. The transmitter 9 applies a drive signal to the transmitting electrode 7. The receiver 10 receives a response signal from the receiving signal 8 that responds to the drive signal applied to the transmitting electrode 7 and outputs a level signal at each electrode intersection where the transmitting electrode 7 and the receiving electrode 8 intersect with each other. The controller 11 detects a touch position based on the level signal output from the receiver 10 and controls operations of the transmitter 9 and the receiver 10.

The transmitting electrode 7 and the receiving electrode 8 intersect in a stacked state with an insulating layer therebetween. A capacitor is formed at the electrode intersection where the transmitting electrode 7 and the receiving electrode 7 intersect. A pointing object, such as a finger, approaches or comes into contact with the touch surface 6 as a user performs a touch operation with the pointing object. Then, the capacitance at the electrode intersection is substantially reduced, thus allowing detection of the touch operation.

A mutual capacitance system is employed herein. A drive signal is applied to the transmitting electrode 7, and then a charge-discharge current flows to the receiving electrode 8 in response. The charge-discharge current is output from the receiving electrode 8 as a response signal. A variation in the capacitance at the electrode intersection at this time in response to a user's touch operation varies the response signal of the receiving electrode 8. A touch position is calculated based on the variation amount. In this mutual capacitance system, a level signal obtained from signal processing of the response signal in the receiver 10 is output for each electrode intersection of the transmitting electrode 7 and the receiving electrode 8, thus enabling what is commonly-called multi-touch (multiple point detection), which simultaneously detects a plurality of touch positions. Of course, other systems can be utilized, and are within the scope of the instant disclosure.

The transmitter 9 selects the transmitting electrodes 7 one by one and applies drive signals. The receiver 10 selects the receiving electrodes 8 one by one and converts response signals of the receiving electrodes 8 into analog signals and then into digital signals for output. The transmitter 9 and the receiver 10 operate in response to a synchronization signal output from the controller 11. During a time when the transmitter 9 applies a drive signal to one transmitting electrode 7, the receiver 10 selects the receiving electrodes 8 one by one and sequentially processes response signals from the receiving electrodes 8. Sequentially repeating this scanning of one line for all transmitting electrodes 7 provides a level signal at every electrode intersection.

The controller 11 obtains a touch position (center coordinate of a touch area) based on predetermined calculation of a level signal at each electrode intersection output from the receiver 10. In this touch position calculation, a touch position is calculated by a predetermined interpolating method (e.g., centroid method) from a level signal of each of a plurality of adjacent electrode intersections (e.g., 4×4) in the X direction (array direction of the receiving electrodes 8) and the Y direction (array direction of the transmitting electrodes 7). Thereby, the touch position can be detected at a higher resolution (e.g., 1 mm or less) than the placement pitch (e.g., 10 mm) of the transmitting electrodes 7 and the receiving electrodes 8.

The controller 11 also obtains a touch position every frame period in which reception of a level signal at each electrode intersection is completed across the touch surface 6 and outputs the touch position information to the PC 2 in units of frames. Based on the touch position information of a plurality of temporally continuing frames, the PC 2 generates and outputs to the display 3, display screen data of touch positions connected in time series. In a case where touch operations are simultaneously performed at a plurality of positions, the touch position information including the plurality of touch positions is output in units of frames.

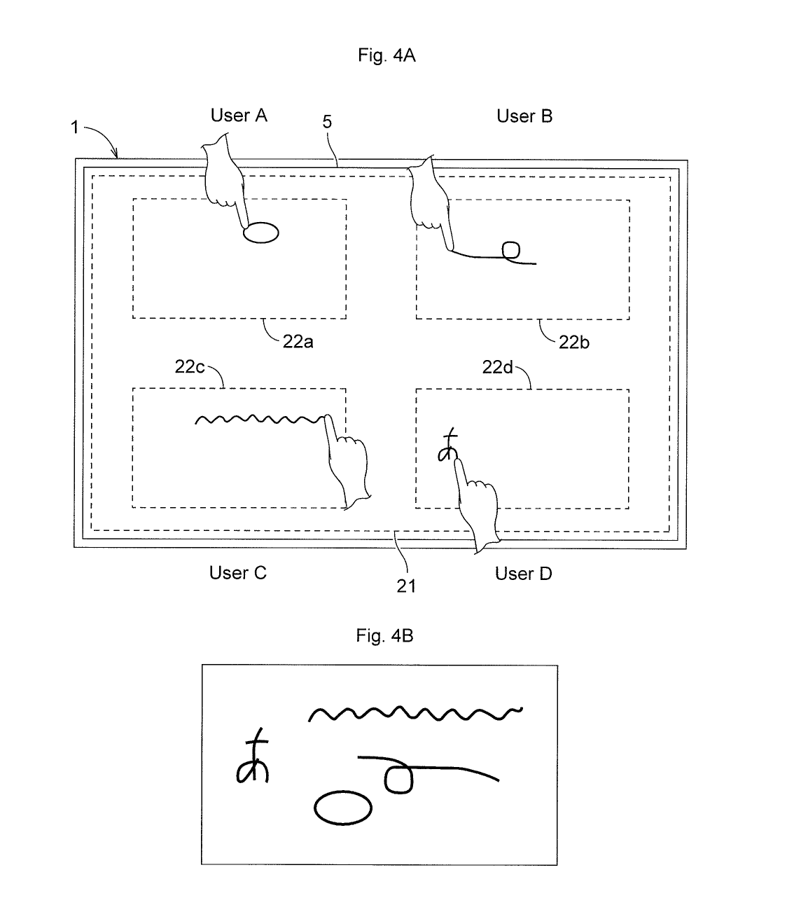

FIGS. 4A and 4B each illustrate a state in which operation areas 22a to 22d are set for the users A to D, respectively, for screen operation. FIG. 4A illustrates the touch table apparatus 1 on which the users A to D perform screen operations. FIG. 4B illustrates a screen displayed on the display 3.

In the present embodiment, the operation areas 22a to 22d for the users A to D, respectively, are individually set within a touch detection area 21 of the touch panel main body 5. Thus, a position input device is virtually assigned exclusively for each of the users A to D. With the operation areas 22a to 22d set for the users A to D, respectively, within reach, the users A to D each can perform a position input operation on the entire screen without moving from their seats, thus enhancing convenience.

In the operation areas 22a to 22d, the users perform touch operations to operate the screen, specifically, to move a pointer (cursor) on the screen, to select a button on the screen, and to draw a line. FIGS. 4A and 4B each illustrate an example in which a line is drawn in a hand-writing mode. The users A to D move their fingers in the operation areas 22a to 22d, respectively, as shown in FIG. 4A. Then, lines associated with the finger movements of the respective users A to D are displayed together on the screen of display 3, as shown in FIG. 4B.

In the present embodiment, in a case where a touch position is not included in any of the operation areas 22a to 22d, specifically, a touch position is out of the operation areas 22a to 22d, the touch position is processed as invalid. Thus, a position input operation cannot be performed outside the operation areas 22a to 22d. Furthermore, even when the users A to D place their hands or an object outside the operation areas 22a to 22d, erroneous detection as a touch position can be prevented, thus improving usability.

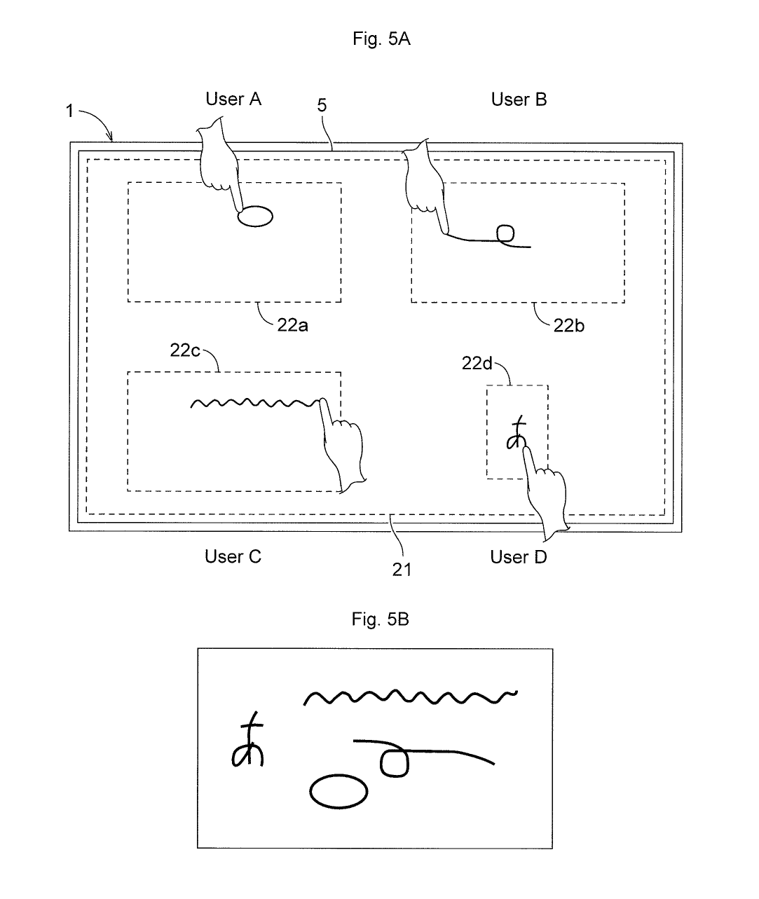

FIGS. 5A and 5B each illustrate a state in which the operation areas 22a to 22d are set for the users A to D, respectively, for screen operation in another example. FIG. 5A illustrates the touch table apparatus 1 on which the users A to D perform screen operations. FIG. 5B illustrates a screen displayed on the display 3.

In the present embodiment, each of the operation areas can be set to an absolute coordinate mode or a relative coordinate mode according to a coordinate mode selected by each of the users A to D, the absolute coordinate mode outputting a coordinate of a touch position with an absolute coordinate, the relative coordinate mode outputting a coordinate of a touch position with a relative coordinate. In the example of FIGS. 5A and 5B, the operation areas 22a to 22c of the users A to C, respectively, are set to the absolute coordinate mode and the operation area 22d of the user D is set to the relative coordinate mode.

In the absolute coordinate mode, the operation areas 22a to 22c each correspond to the entire screen area, similar to a tablet, and a coordinate value indicating an absolute position on each of the operation areas 22a to 22c is output. In the relative coordinate mode, a coordinate value indicating a position relative to a position pointed immediately prior thereto is output, similar to a mouse.

Since the absolute coordinate mode or the relative coordinate mode can be set separately for each of the operation areas, the absolute coordinate mode or the relative coordinate mode can be selected depending on user's needs, thus improving convenience.

It is basically unnecessary to set an operation area in particular in the relative coordinate mode. Without a boundary of an operation area, however, erroneous detection of a user's hand or an object placed on the touch surface 6 cannot be prevented, causing inconvenience. Thus, it is preferable to set an operation area even in the relative coordinate mode.

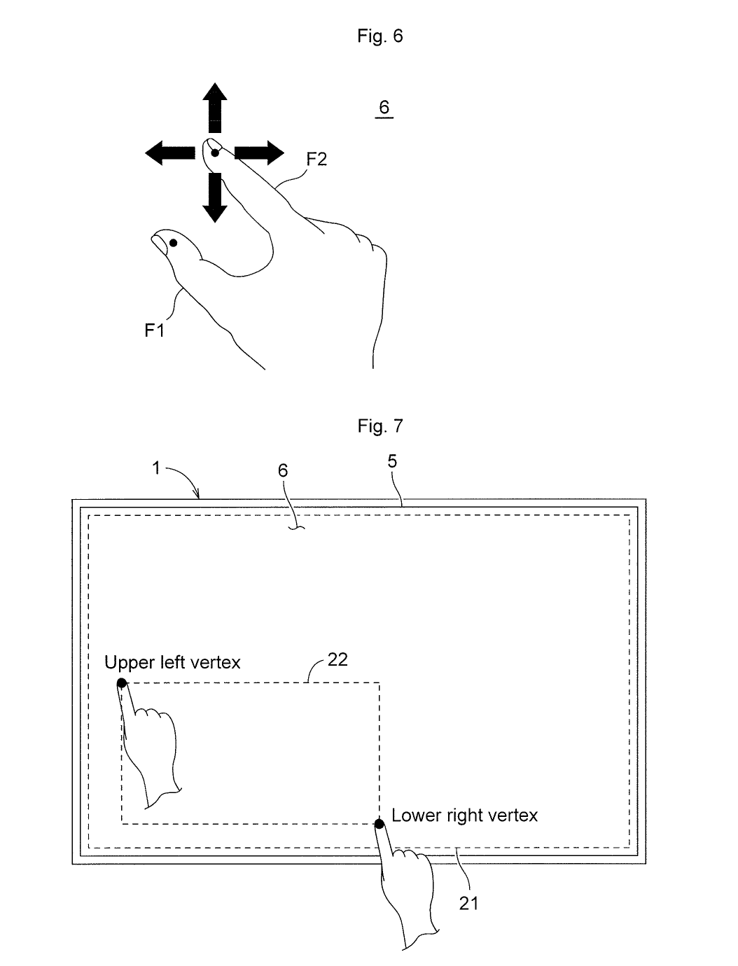

FIG. 6 illustrates two-finger operation mode in which two fingers are used for position input operation. In the present embodiment, a user keeps a first finger F1 still (or stationary) in contact with the touch surface 6 and moves a second finger F2 to enter a position. Based on a relative position of the second finger F2 to the still first finger F1, a coordinate value of the touch position is output with a relative coordinate.

In the example of FIG. 6, the two fingers of one hand are used. Alternatively, one finger of each of the hands may be used.

FIG. 7 illustrates a state in which an operation area 22 is designated on the touch table apparatus 1. To designate the operation area 22, two diagonal vertexes (upper left and lower right herein) that define the rectangular operation area 22 are designated by touch operations. Thus, the rectangular operation area 22 is defined such that the two vertexes are passed or intersected and four sides are provided in parallel to each side of the touch detection area 21.

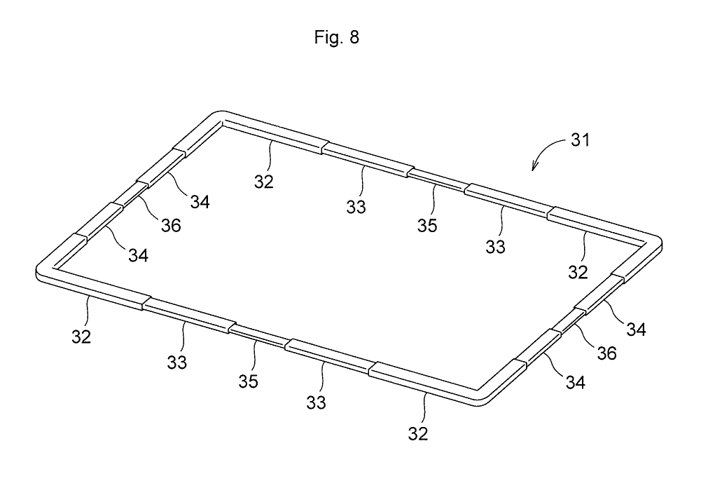

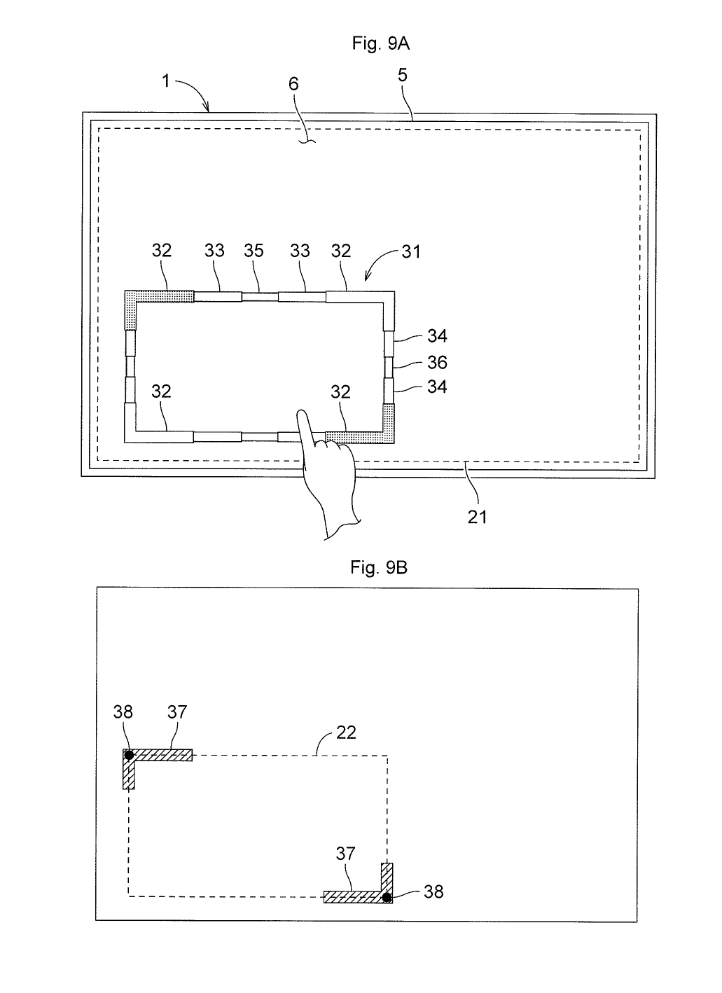

The operation area is designated by touch operations by a user as above. Alternatively, an area designation tool may be used to designate an operation area as described below. FIG. 8 is a perspective view of an area designation tool 31. FIGS. 9A and 9B each illustrate a state in which an area is designated using the area designation tool 31. FIG. 9A illustrates a state in which the area designation tool 31 is placed on the touch table apparatus 1. FIG. 9B illustrates a touch area that appears within a touch detection area.

With reference to FIG. 8, the area designation tool 31, which has a rectangular shape to define an operation area thereinside, is extendable and contractable on each side with a telescopic mechanism so as to change the size. Specifically, the area designation tool 31 has an angular member 32, side members 33 and 34, and side members 35 and 36. The angular member 32 having an L shape and a large diameter or cross-section is positioned at a corner portion. The side members 33 and 34 each having a medium diameter or cross-section are detachably fitted into the angular member 32. The side member 35 and 36 each having a tubular shape and a small diameter or cross-section are detachably fitted into the side members 33 and 34, respectively. Of the four angular members 32 of the area designation tool 31, at least two diagonally positioned members are formed of conductive bodies.

The area designation tool 31 is placed on the touch surface 6 of the touch table apparatus 1 as shown in FIG. 9A. Then, an L-shaped touch area 37 is detected based on the position of the angular member 32 formed of a conductive body as shown in FIG. 9B. Thus, it is detected that the area designation tool 31 is placed or positioned on the touch surface. Then, an angular point 38 of the L-shaped touch area 37 is set as each of two diagonal vertexes that define the rectangular operation area 22, and thus the operation area 22 is determined.

A user can perform a touch operation on the touch surface 6 inside the area designation tool 31 as shown in FIG. 9A. Since the operation area 22 is partitioned by the area designation tool 31, the user can visually confirm a range of the operation area 22. The user can thus prevent the inconvenience of being unsure of a range of the operation area 22 after designating the operation area 22 by touch operations, as in the case of FIG. 7, thus improving convenience.

A configuration associated with the operation area of the touch table apparatus 1 and the PC 2 is explained below. Operation procedures of the touch table apparatus 1 and the PC 2 are also explained.

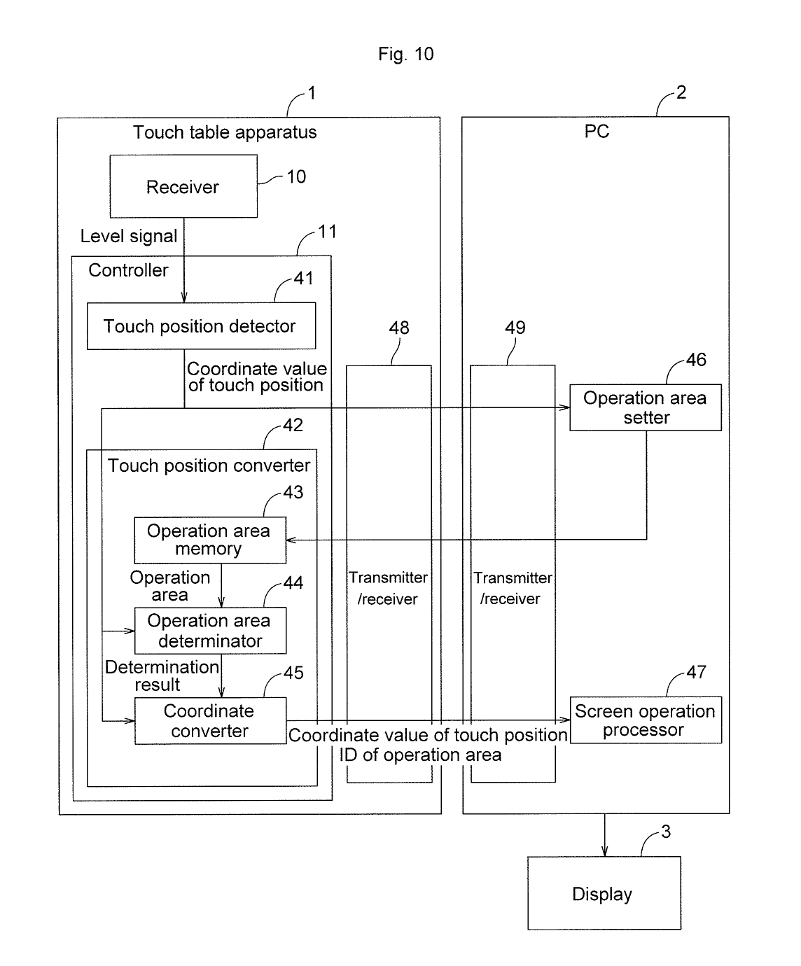

FIG. 10 is a functional block diagram of the touch table apparatus 1 and the PC 2. The controller 11 of the touch table apparatus 1 has a touch position detector 41, a touch position converter 42, and a transmitter/receiver 48. The touch position detector 41 detects a touch position within the touch detection area 21 of the touch panel main body 5, based on a level signal output from the receiver 10. In a case where users perform touch operations simultaneously, a plurality of touch positions are detected simultaneously. The touch position detector 41 outputs a coordinate value of a touch position in a coordinate system of the touch table. A touch position obtained by the touch position detector 41 during operation area designation is directly transmitted from the transmitter/receiver 48 to the PC 2.

The touch position converter 42 converts a touch position obtained by the touch position detector 41 into a touch position of each operation area and outputs the converted touch position. In particular, the touch position converter 42 converts a coordinate of a touch position obtained in the operation area for each user set within the touch detection area of the touch table apparatus 1 into a coordinate in the screen area of the PC 2. The touch position converter 42 has an operation area memory 43, an operation area determinator 44, and a coordinate converter 45.

The operation area memory 43 stores information (coordinate value) on the position of the operation area set within the touch detection area 21, the information being transmitted from the PC 2 and being received by the transmitter/receiver 48. Based on the information on the operation area stored in the operation area memory 43, the operation area determinator 44 determines in which operation area a touch position obtained by the touch position detector 41 is included. When the touch position is not included in any operation area, specifically, when the touch position is located outside the operation area, the operation area determinator 44 invalidates the touch position. Based on the information on the operation area stored in the operation area memory 43, the coordinate converter 45 converts a coordinate value of the touch position obtained by the touch position detector 41 from a coordinate system of the touch table to a coordinate system of an output screen (e.g., display 3) of the PC 2. The converted coordinate value of the touch position by the coordinate converter 45 is transmitted from the transmitter/receiver 48 to the PC 2 along with an ID (identification information) of the operation area obtained by the operation area determinator 44.

When the touch position converter 42 detects that two fingers F1 and F2 touch simultaneously as shown in FIG. 6, the touch position converter 42 switches to a two-finger operation mode to output a coordinate value of a touch position with a relative coordinate, based on a relative position of the second finger F2 to the still or stationary first finger F1.

The PC 2 has an operation area setter 46, a screen operation processor 47, and a transmitter/receiver 49. The operation area setter 46 sets an operation area within the touch detection area individually for each user, based on a touch position obtained by the touch position detector 41 of the touch table apparatus 1 during operation area designation and received by the transmitter/receiver 49. Information on the position of the operation area obtained herein is transmitted from the transmitter/receiver 49 to the touch table apparatus 1 and is stored in the operation area memory 43 of the touch table apparatus 1.

The screen operation processor 47 reflects an operation performed in the operation area of each user in the same screen area, based on a coordinate of the screen area obtained by the touch position converter 42 during screen operation and received by the transmitter/receiver 49. The screen operation processor 47 perfoi ins processing corresponding to touch operations to operate the screen by a user, specifically, to move a pointer (cursor) on the screen, to select a button on the screen, and to draw a line, based on a coordinate value of a touch position and an ID (identification information) of an operation area received from the touch table apparatus 1.

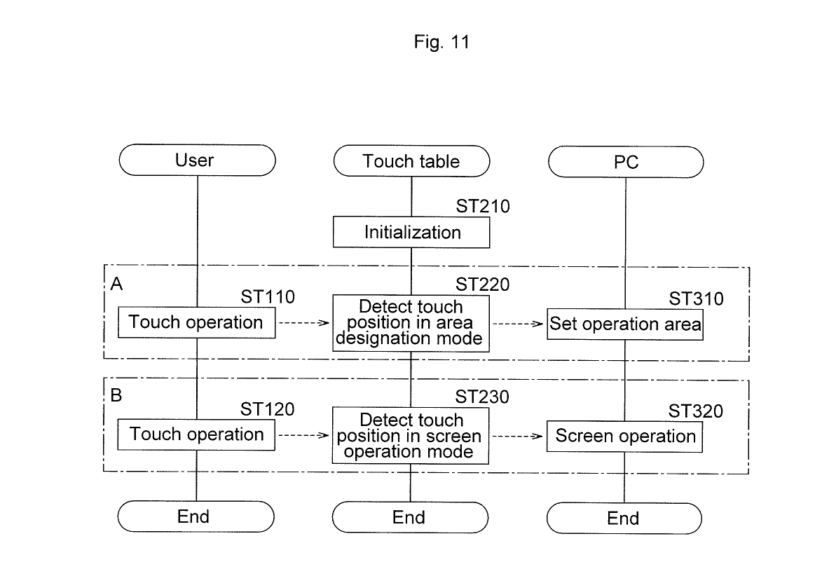

FIG. 11 is a flowchart illustrating processing procedures in the touch table apparatus 1 and the PC 2. First, the touch table apparatus 1 is turned on, and then is initialized (ST 210). In the initialization, a level signal is obtained in an untouched state in which no touch operation is performed. This allows the touch position detector 41 to detect a touch position based on a change amount of the level signal associated with a touch operation.

The PC 2 starts an application for screen operation using the touch table apparatus 1 and performs, in the operation area setter 46, operation area setting processing that allows a user to designate an operation area. At this time, the touch table apparatus 1 enters an area designation mode. The user performs a touch operation to designate an operation area (ST 110), and then the touch table apparatus 1 performs touch position detection processing in the touch position detector 41 (ST 220) and transmits touch position information to the PC 2. The PC 2 sets an operation area based on the touch position (ST 310).

After the operation area is set as above, the touch table apparatus 1 enters a screen operation mode to allow a position input operation in the operation area. The user performs a touch operation for screen operation (ST 120). Then, the touch table apparatus 1 performs touch position detection processing in the touch position detector 41 (ST 230) and transmits touch position information to the PC 2. The PC 2 performs screen operation processing in the screen operation processor 47 based on the touch position (ST 320).

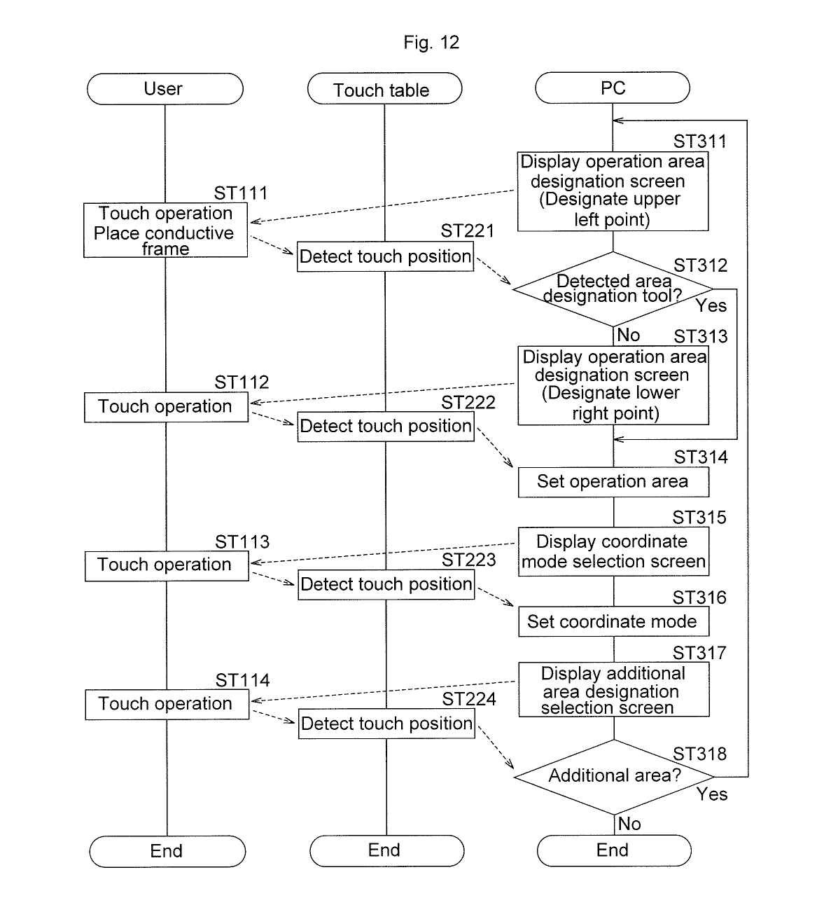

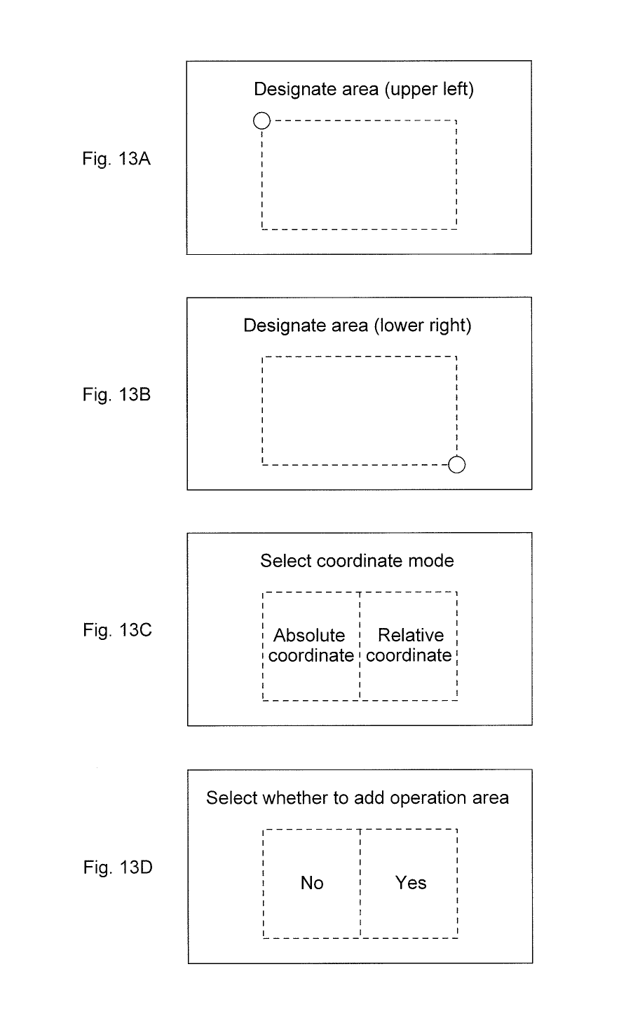

Processing during operation area designation shown in a portion A of FIG. 11 is described in detail below. FIG. 12 is a flowchart illustrating processing procedures for operation area designation shown in the portion A of FIG. 11. FIGS. 13A to 13D each illustrate a screen displayed on the display 3 during operation area designation. Specifically, FIGS. 13A and 13B each illustrate a screen prompting a user to designate an operation area; FIG. 13C illustrates a screen prompting the user to select a coordinate mode; FIG. 13D illustrates a screen prompting the user to select whether or not to add an operation area.

With reference to FIG. 12, the PC 2 first performs in the operation area setter 46 processing for displaying on the display 3 an operation area designation screen (refer to FIG. 13A) that prompts a user to designate one vertex (upper left herein) to define an operation area (ST 311). In response, the user touches a predetermined position on the touch surface 6 or places the area designation tool 31 in a predetermined position on the touch surface 6 (ST 111). Then, the touch table apparatus 1 performs touch position detection processing in the touch position detector 41 (ST 221) and transmits a detected touch position to the PC 2.

The PC 2 performs, in the operation area setter 46, processing for detecting the area designation tool 31 based on the touch position received from the touch table apparatus 1 (ST 312). When the PC 2 does not detect the area designation tool 31 (ST 312: No), the PC 2 performs, in the operation area setter 46, processing for displaying on the display 3 the operation area designation screen (refer to FIG. 13B) that prompts the user to designate the other vertex (lower right herein) to define the operation area (ST 313). In response, the user touches a predetermined position on the touch surface 6 (ST 112). Then, the touch table apparatus 1 performs touch position detection processing in the touch position detector 41 (ST 222) and transmits a detected touch position to the PC 2. The PC 2 performs operation area setting in the operation area setter 46 based on the two obtained vertexes (upper left and lower right) (ST 314).

When the PC 2 detects the area designation tool 31 (ST 312: Yes), it is unnecessary to designate the other vertex to define the operation area. Thus, the PC 2 eliminates display of the operation area designation screen that prompts the user to designate the vertex (ST 313), and performs operation area setting in the operation area setter 46 based on the placement position of the area designation tool 31 (ST 314).

Subsequently, the PC 2 performs, in the operation area setter 46, processing for displaying on the display 3 a coordinate mode selection screen (refer to FIG. 13C) that prompts a user to select an absolute coordinate mode or a relative coordinate mode (ST 315). In response, the user touches the touch surface 6 to select a predetermined coordinate mode (ST 113). When the user touches the right half area according to the indication on the display 3, the “relative coordinate” is selected, whereas when the user touches the left half area, the “absolute coordinate” is selected. At this time, the touch table apparatus 1 performs touch position detection processing in the touch position detector 41 (ST 223) and transmits a detected touch position to the PC 2. The PC 2 determines the coordinate mode selected by the user based on the obtained touch position and performs coordinate mode setting processing in the operation area setter 46 (ST 316).

Subsequently, the PC 2 performs in the operation area setter 46 processing for displaying on the display 3 an additional area selection screen (refer to FIG. 13D) that prompts a user to select whether or not to add an operation area (ST 317). In response, the user touches the touch surface 6 so as to select whether or not to add an operation area (ST 114). When the user touches the right half area according to the indication on the display 3, “Yes” is selected, whereas when the user touches the left half area, “No” is selected. At this time, the touch table apparatus 1 performs touch position detection processing in the touch position detector 41 (ST 224) and transmits a detected touch position to the PC 2. The PC 2 determines whether or not to add an operation area based on the obtained touch position (ST 318). When there is an operation area to be added (ST 318: Yes), the PC 2 returns to the operation area designation screen (ST 311) to allow the user to designate a new operation area.

After setting the position and the coordinate mode of the operation area in the operation area setter 46, the PC 2 transmits the information on the position and the coordinate mode of the operation area to the touch table apparatus 1 to be stored in the operation area memory 43.

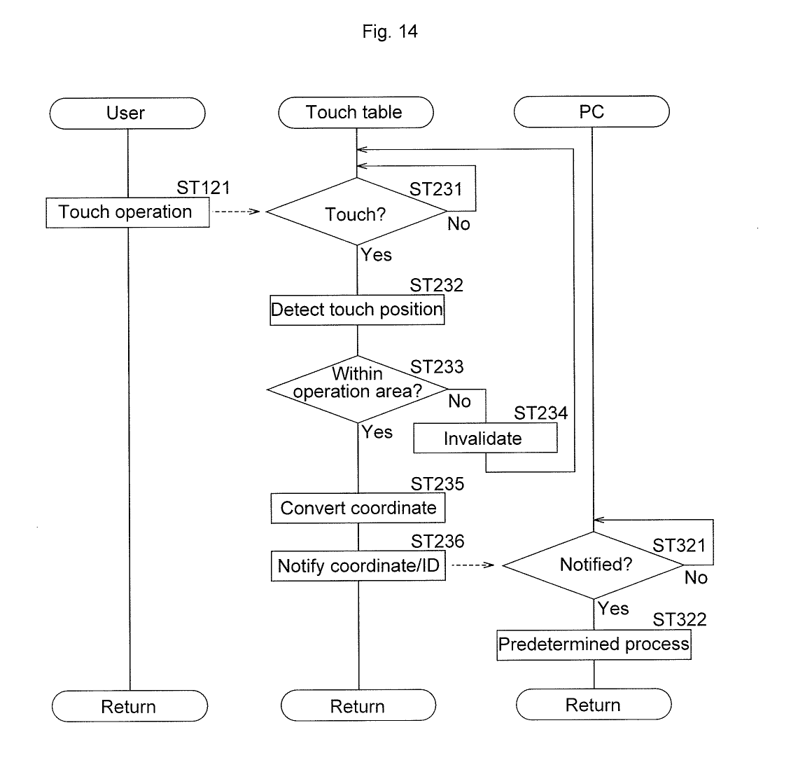

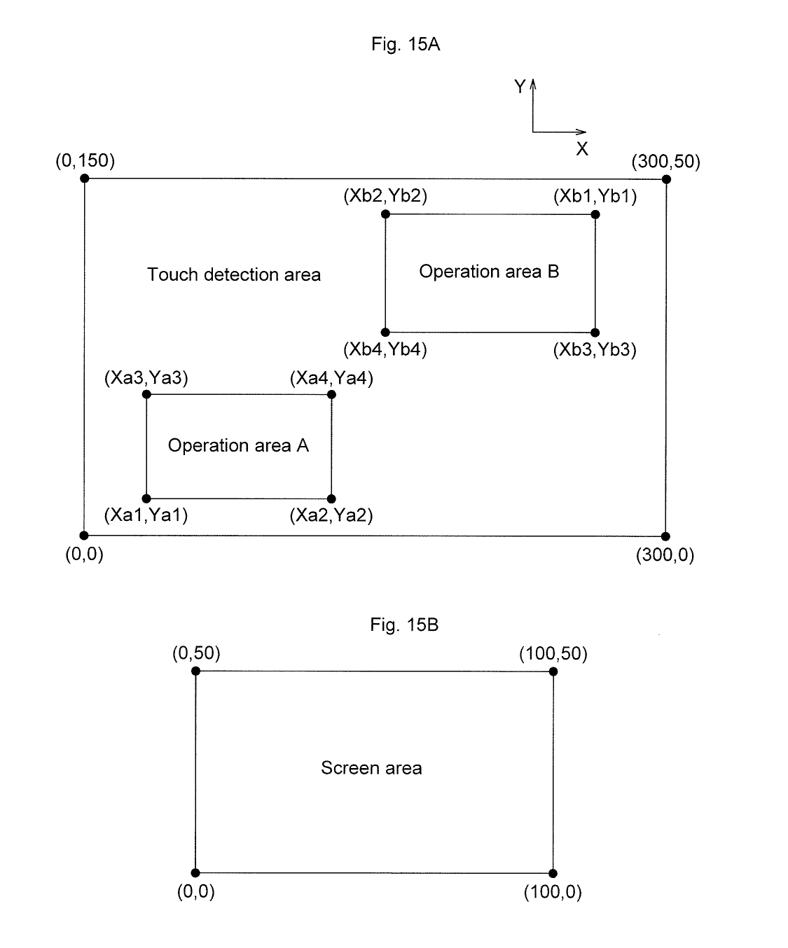

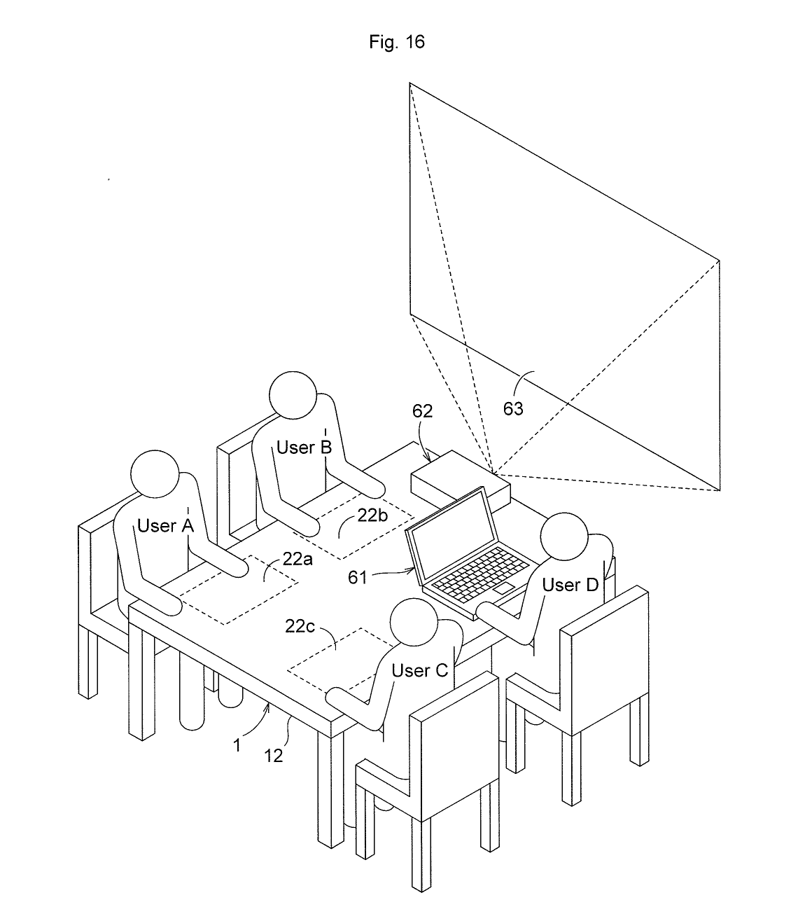

Processing during screen operation shown in a portion B of FIG. 11 is described in detail below. FIG. 14 is a flowchart illustrating processing procedures for screen operation shown in the portion B of FIG. 11. FIGS. 15A and 15B each illustrate a state of coordinate conversion during screen operation. Specifically, FIG. 15A illustrates a coordinate system of a touch table; FIG. 15B illustrates a coordinate system of an output screen.

With reference to FIG. 14, the user performs a touch operation for screen operation (ST 121), the touch table apparatus 1 detects the touch operation (ST 231: Yes) and performs touch position detection processing in the touch position detector 41 (ST 232). In the touch position detection processing, a touch position is obtained in the coordinate system of the touch table.

Subsequently, operation area determination processing is performed in the operation area determinator 44 (ST 233). In the operation area determination processing, an operation area is determined in which the touch position obtained in the touch position detection processing (ST 232) is included, based on the operation area information in the operation area memory 43. When the touch position is not included in any operation area (ST 233: No), the touch position is invalidated (ST 234).

When the touch position is included in any operation area (ST 233: Yes), coordinate conversion processing is performed in the coordinate converter 45 (ST 235). In the coordinate conversion processing, a coordinate value of the touch position obtained in the touch position detection processing (ST 232) is converted from the coordinate system of the touch table shown in FIG. 15A into the coordinate system of the output screen shown in FIG. 15B.

In the example shown in FIG. 15A, both operation areas A and B are set in the absolute coordinate mode. In the operation area A, coordinate values (Xa1, Ya1) to (Xa4, Ya4) in the coordinate system of the touch table are converted into coordinate values (0, 0) to (100, 50) in the coordinate system of the output screen. In the operation area B, coordinate values (Xb1, Yb1) to (Xb4, Yb4) in the coordinate system of the touch table are converted into coordinate values (0, 0) to (100, 50) in the coordinate system of the screen of the PC 2.

The operation areas A and B are provided for two users opposite to each other with the touch table apparatus 1 therebetween. The operation area relative to the user has a positional relationship of 180 degrees. The operation area may have a positional relationship of 90 degrees depending on the position of the user, and the positional relationship is not constant. Thus, during operation area setting, the user is asked to enter the positional relationship of the operation area. Based on the entered information, coordinate conversion is performed so as to match the up, down, left, and right of the operation area as viewed from the user and the up, down, left, and right of the screen area. The coordinate conversion associated with the positional relationship of the operation area relative to the user is also required for the relative coordinate mode and the two-finger operation mode in addition to the absolute coordinate mode.

Then, as shown in FIG. 14, the touch table apparatus 1 notifies the PC 2 of the touch position information (ST 236). Specifically, the touch table apparatus 1 transmits to the PC 2, the ID (identification information) of the operation area obtained in the operation area determination process (ST 233) and the coordinate value in the coordinate system of the output screen obtained in the coordinate conversion processing (ST 235). Upon receiving the touch position information from the touch table apparatus 1 (ST 321: Yes), the PC 2 determines the content of the screen operation based on the touch position and performs predetermined processing associated with the content of the screen operation (ST 322).

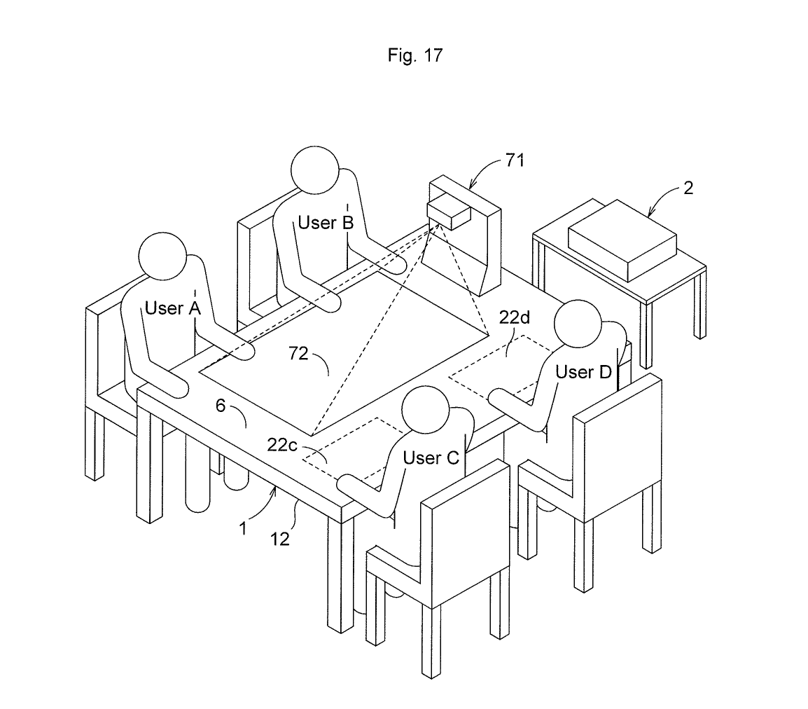

FIGS. 16 and 17 are each a perspective view illustrating an alternative example of use of the touch table system.

In the example shown in FIG. 16, a laptop PC (information processing apparatus) 61, instead of the desktop PC 2 above, is placed on the tabletop 12 of the touch table apparatus 1. For enlarged display of a screen of the laptop PC 61, a projector (display apparatus) 62 is used to project the screen on a screen or a wall surface in a room as a projection surface 63.

In this case, normally only the user D in front of the laptop PC 61 can operate the screen. The remaining users A to C can also operate the screen by moving the laptop PC 61. However, setting the operation areas 22a to 22c for the users A to C, respectively, on the touch table apparatus 1 allows the users A to C to each operate the screen of the laptop PC 61 without moving the laptop PC 61.

In the example shown in FIG. 17, a projector (display apparatus) 71 is used similar to the example above. The projector 71, which is of a short focus type, is placed on the tabletop 12 of the touch table apparatus 1. The touch surface 6 of the upper surface of the tabletop 12 is used as a projection surface to project a screen of the projector 71 so as to display the screen of the PC 2.

In this case, a screen display area 72 is set as an operation area on the touch surface 6 of the touch table apparatus 1, allowing a user to operate the screen as if directly operating the screen displayed in the screen display area 72. In particular, in this example, the screen is displayed proximate to the users A and B, who thus can operate the screen with a touch operation on the screen display area 72. The operation areas 22c and 22d are set for the users C and D, respectively, who are unable to reach the entire screen display area 72, to allow them to operate the screen without moving from their seats.

In the present embodiment, a standalone display apparatus (display 3 and projectors 62 and 71) that displays a screen is used. Alternatively, the touch table apparatus may be integrally provided with a display apparatus. Specifically, a display apparatus may be disposed on the rear of the touch panel main body in the tabletop so as to display an image on the touch surface. In this case, the screen may be displayed in a portion of the touch detection area and the operation area may be set in the remaining space.

In the present embodiment, the touch position converter 42 is provided in the touch table apparatus 1, but may be provided in the information processing apparatus (PC 2). In the present embodiment, the operation area setter 46 is provided in the information processing apparatus (PC 2), but may be provided in the touch table apparatus 1.

In the present embodiment, the area designation tool having a frame shape is placed on the touch surface to allow touch operation on the touch surface inside the tool. An area designation tool is not limited to the configuration above in the present invention, and may be a chip-shaped member or an L-shaped member to designate two vertexes that define a rectangular operation area.

In the present embodiment, a mutual capacitance system of an electrostatic capacitance system is employed as a method of detecting a touch position. Alternatively, a self-capacitance system may be employed. The self-capacitance system, however, does not support multi-touch which allows detection of a plurality of touch positions simultaneously, causing inconvenience in use. Thus, it is preferred to employ the mutual capacitance system.

The touch system according to the present invention enhances convenience in use by a plurality of users. The touch system is useful as a touch system having a touch support member apparatus provided with a touch screen.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch system comprising:
a touch support member apparatus having a touch surface on which a touch operation is performed by a user and on which electrodes are arranged in a grid shape; and
an information processing apparatus connected to the touch support member apparatus,
the touch support member apparatus comprising:
a touch position detector configured to detect a touch position on an operation area of the touch surface based on a change of output signals from the electrodes associated with a change in capacitance in response to the touch operation; and
a touch position converter configured to convert a coordinate of the touch position, in the operation area, obtained by the touch position detector, into a coordinate of a screen area of the information processing apparatus.

2. The touch system according to claim 1, wherein the information processing apparatus comprises an operation area setter setting the operation area.

3. The touch system according to claim 2, wherein the operation area setter sets the operation area for the user based on touch positions obtained by the touch position detector.

4. The touch system according to claim 1, wherein the information processing apparatus comprises a screen operation processor reflecting the touch operation performed in the operation area into the screen area based on the coordinate of the screen area converted by the touch position converter.

5. The touch system according to claim 3, wherein the operation area is rectangular, and two diagonal vertexes of the operation area are designated by touch operations by the user.

6. The touch system according to claim 3, further comprising an area designation tool at least partially comprising a conductive body, wherein
the operation area setter sets the operation area based on a placement position of the area designation tool upon detecting the area designation tool based on a detection result of the touch position detector.

7. The touch system according to claim 6, wherein each side of the area designation tool is extendable and contractable.

8. The touch system according to claim 6, wherein each side of the area designation tool has a telescopic mechanism.

9. The touch system according to claim 6, wherein
the area designation tool is rectangular to define the operation area inside the area designation tool,
two diagonally positioned members of the area designation tool are formed of conductive bodies.

10. The touch system according to claim 1, wherein
the operation area setter sets one of an absolute coordinate mode and a relative coordinate mode for the operation area according to a coordinate mode selection operation by a user, the absolute coordinate mode outputting a coordinate value of a touch position with an absolute coordinate, the relative coordinate mode outputting a coordinate value of a touch position with a relative coordinate, and
the touch position converter outputs a coordinate indicating a touch position relative to an immediately precedingly designated touch position, for the operation area set in the relative coordinate mode.

11. The touch system according to claim 1, wherein the touch position converter comprises an operation area memory that stores information on the operation area set by the operation area setter, and an operation area determinator that determines whether or not the touch position detected by the touch position detector is in the operation area.

12. The touch system according to claim 11, wherein the operation area determinator invalidates the touch position when the operation area determinator determines that the touch position is not in the operation area.

13. The touch system according to claim 1, wherein the touch position converter switches to a two-finger operation mode to output a coordinate value of a touch position with a relative coordinate, based on a relative position of one finger to another finger, when the touch position converter detects that the two fingers touch the touch surface simultaneously.

14. A touch system comprising:
a touch support member apparatus having a touch surface on which touch operations are performed by a plurality of users and on which electrodes are arranged in a grid shape; and
an information processing apparatus connected to the touch support member apparatus,
the touch support member apparatus comprising:
a touch position detector configured to detect touch positions on a plurality of operation areas of the touch surface based on changes of output signals from the electrodes associated with changes in capacitance in response to the touch operations; and
a touch position converter configured to convert coordinates of the touch positions, in the operation areas, obtained by the touch position detector, into coordinates of a screen area of the information processing apparatus, wherein
each of the operation areas comprises a position input device assigned to one of the users.

15. The touch system according to claim 14, each of the plurality of operation areas being configured to input a touch operation over the entire screen area of the information processing apparatus.

16. The touch system according to claim 14, wherein
the operation area setter sets one of an absolute coordinate mode and a relative coordinate mode for each operation area according to a coordinate mode selection operation by a user, the absolute coordinate mode outputting a coordinate value of a touch position with an absolute coordinate, the relative coordinate mode outputting a coordinate value of a touch position with a relative coordinate, and
the touch position converter outputs a coordinate indicating a touch position relative to an immediately precedingly designated touch position, for an operation area set in the relative coordinate mode.

17. The touch system according to claim 16, the touch position converter being configured to convert coordinates of a plurality of touch positions in a plurality of operation areas into coordinates of the screen area of the information processing apparatus, the operation area setter being configured to concurrently set at least one of the plurality of operation areas to the absolute coordinate mode and at least one of the plurality of operation areas to the relative coordinate mode.

18. The touch system according to claim 16, wherein, in the relative coordinate mode, a position input operation comprises moving a second contact member with respect to a fixedly positioned contact member.

19. The touch system according to claim 14, the information processing apparatus comprises a laptop with a display on the touch surface and a projector containing the screen area, each of the plurality of operation areas and the laptop being configured to control the display of the laptop.

20. The touch system according to claim 14, the information processing apparatus comprising a projector, a projector area of the projector being projected onto the touch surface and comprising one of the plurality of operation areas.
